(19) United States
(12) Patent Application Publication
(10) Pub. No.: US 2016/0321658 A1
(43) Pub. Date: Nov. 3, 2016

(54) METHOD FOR LEVERAGING MULTIPLE PRODUCTS

(71) Applicant: MasterCard International Incorporated, Purchase, NY (US)

(72) Inventors: Kenny Unser, Fairfield, CT (US); Jean-Pierre Gerard, Croton-On-Hudson, NY (US)

(21) Appl. No.: 14/697,988

(22) Filed: Apr. 28, 2015

(51) Int. Cl. G06Q 20/40

(52) U.S. Cl. CPC G06Q 20/405

(57) ABSTRACT

A method and system include receiving, by a leverage/module, data associated with a purchase transaction; determining that an account identifier associated with the received data identifies a composite account, wherein the composite account includes a collection of two or more card products; analyzing, by the leverage module, composite account data to determine at least one card product of the collection of card products to process the purchase transaction; selecting, by the leverage module, an account associated with at least one card product to process the purchase transaction based on the analysis; transmitting, by the leverage module, the selected at least one account to an issuer of the selected at least one card product for authorization of the purchase transaction. Numerous other aspects are provided.

### BACKGROUND

Payment card systems are in widespread use. A prominent payment card system is operated by the assignee hereof, MasterCard International Incorporated, and by its member financial institutions. FIG. 1 schematically illustrates a typical transaction, as carried out by using a conventional payment system 100. To initiate the transaction, a customer (not shown) visits a retail store (not shown) operated by a merchant, selects goods (not shown) that he/she wishes to purchase, carries the goods to the merchant's point of sale terminal 104, and presents his/her payment card 102 to the point of sale terminal 104. The point of sale terminal 104 reads the customer's payment card account number from the payment card 102, and then sends an authorization request to an acquirer financial institution (FI) 106, with which the merchant has a relationship. The authorization request typically includes the payment card account number (PAN), the amount of the transaction, and other information. The authorization request is routed via a payment card network 108 to the issuer financial institution (FI) 110 that issued the customer's payment card 102. Arrows 112, 114 and 116 trace the path of the authorization request from the POS terminal 104 to the issuer 110.

Assuming that all is in order, the issuer FI 110 transmits a favorable authorization response to the point of sale terminal 104 through the payment card network 108 and via the acquirer FI 106. (The path of the authorization response from the issuer FI 110 to the POS terminal 104 is traced by arrows 118, 120, 122.) The transaction at the point of sale terminal 104 is then completed and the customer leaves the store with the goods. A subsequent clearing transaction initiated by the merchant results in a transfer of the transaction amount from the customer's payment card account 124 to an account that belongs to the merchant. The customer's payment card account 124 may be, for example, either a debit card account or a credit card account. In the former case, the clearing transaction results in the funds being debited directly from the account 124. In the latter case, the clearing transaction results in a charge being posted against the account 124, and the charge subsequently appears on the customer's monthly credit card statement.

The foregoing description of the typical transaction may be considered to be somewhat simplified in some respects. For example, a merchant processing system (not shown) may be interposed between the POS terminal and the acquirer FI. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service, such as a payment services provider (PSP), may operate to handle payment card transactions on behalf of the acquirer and on behalf of a large number of other like financial institutions.

Many consumers/cardholders currently carry and/or use two or more payment card products, including credit, debit and pre-paid cards. The payment card products, and by extension, associated accounts, may be sponsored by one or more issuer FIs. A cardholder may choose to use different cards for different types of transactions based on, for example, a rewards incentive system or credit terms offered for a particular card, in addition to other points of differentiation. For example, a cardholder may use one card product to collect premium rewards for gas purchases, while another card may be used to collect “cash back” rewards for non-gas purchases. However, cardholders who use multiple card products may not like carrying so many cards, and may have difficulty remembering which card they prefer to use for a particular purchasing transaction. For example, a particular rewards credit card product issuer may offer 5% cashback reward on gasoline purchases and 1% cashback reward on all other purchases, while another card product issuer offers 3% cashback on all purchases. The cardholder may want to take advantage of these rewards, but may not remember which card product is associated with each reward.

The present inventors have recognized that there is a need for methods and/or systems to automatically select a particular payment card product from a cardholder's collection of payment card products, based on prior input from the cardholder.

### BRIEF DESCRIPTION OF THE DRAWINGS

FIG. 1 is a block diagram that illustrates a conventional payment system;

FIG. 2 is a block diagram that illustrates a transaction-handling system configured to operate in accordance with aspects of some embodiments herein;

FIG. 3 is a flow diagram illustrating a process that may be performed in accordance with aspects of some embodiments herein;

FIG. 4 is a block diagram illustrating a card product leveraging computer system according to an embodiment of the invention;

FIG. 5 is a table in accordance with some aspects of some embodiments herein; and

FIG. 6 is a flow diagram illustrating a process that may be performed in accordance with aspects of some embodiments here.

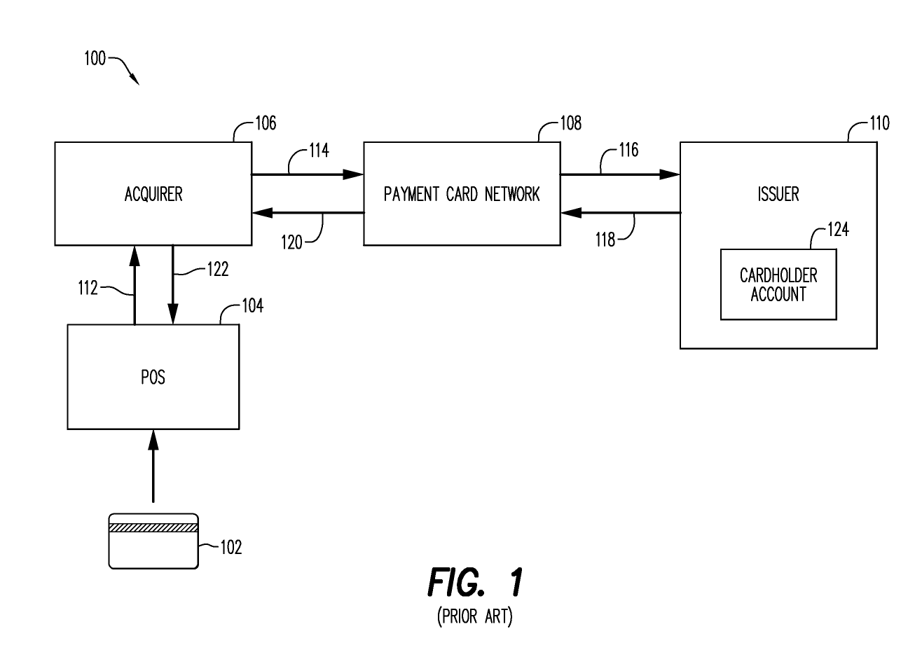

### DETAILED DESCRIPTION

Embodiments of the invention provide methods and/or systems to leverage different payment card products to maximize the cardholder value for a card product holder during a purchase transaction, without the card product holder having to remember parameters for each card product. In some embodiments, the methods and/or systems function to automatically select or extract a particular payment card product from a cardholder's collection of payment card products, based on prior input from the cardholder, and automatically forward an authorization request and account information associated with this selected payment card product to the issuer of the payment card product, without further input from the cardholder.

A number of terms will be used herein. The use of such terms is not intended to be limiting, but rather is used for convenience and ease of exposition. For example, as used herein, the term “cardholder” may be used interchangeably with the term “consumer” and “card product holder” and are used herein to refer to a consumer, individual business or other entity that has been issued (or authorized to use) a financial account such as a credit or debit account. The financial account may be accessed by use of a “payment card” or “payment card product” or “payment device” such as a traditional plastic or embossed magnetic stripe card, a chip card (such as an EMV card) or an RFID card (such as a PayPass™ or MasterPass™ payment card.) Pursuant to some embodiments, as used herein, the term “payment card” or “payment device” may also include a mobile device (such as a mobile telephone or table computer) operating a payment application that includes stored payment account information. As used herein, the term “card product” and “financial account associated with the card product” may be used interchangeably.

In some embodiments, a cardholder or customer registers for a card product leveraging service by providing information concerning the payment accounts (such as credit card accounts, debit card accounts, and/or gift card accounts) the cardholder wants to register to a card product leveraging computer system. In some embodiments, a cardholder or customer who owns a payment enabled mobile device (such as a smartphone, a mobile telephone, a tablet computer, a laptop computer, a personal digital assistant (PDA) and the like) registers for a card product leveraging service by providing information concerning the payment accounts (such as credit card accounts, debit card accounts, and/or gift card accounts) in his or her digital wallet to a card product leveraging computer system. When the registered cardholder enters into a purchase transaction at a retail store, or at an online store, purchase transaction information may be transmitted from a merchant's device (such as a point of sale (POS) terminal), in the retail store, or the merchant's computer in the online store, to the card product leveraging computer system for use thereby. The purchase transaction information may include data such as an amount due for the purchase, a merchant identifier, a time and date of transaction, transaction location, and product identification details such as descriptions and/or identifiers for each item being purchased (and its associated purchase price). In some embodiments, a card product leveraging module of the card product leveraging system selects at least one card product to use in the purchase transaction, as further described below, and transmits this selected card product account information to the card product issuer for authorization. The card product selection(s) may be at least partially based on the purchase transaction information and/or other information supplied by the cardholder and/or other entities.

In some embodiments, the card product leveraging computer system includes a card product leveraging module operable to analyze account information to determine and select one or more card product accounts for use in the purchase transaction. The module may utilize the purchase transaction information along with additional data to generate the selection of the card product to be used for that particular purchase transaction. When the card product leveraging module determines two or more card product accounts are available for selection, the card product accounts may be ranked in an order based on the preferences that were preselected by the cardholder such that only one card is selected, per cardholder preferences (e.g., the cardholder preference was not to split the transaction between multiple card product accounts). In other embodiments, the ranking may be made by the module (which may be based on additional data). In some embodiments, the card product leveraging computer system transmits the selected card product account information directly to the card product account issuer. Standard purchase transaction processing may then occur in order to consummate the purchase transaction. However, in some implementations, if the card product account issuer does not authorize the purchase transaction, the denial may be returned to the module, and the module may select another card product to participate in the purchase transaction.

In some embodiments, a cardholder registers for the card product leveraging service by visiting a card product leveraging website and providing requested data, or provides data in some other manner to the system. For example, the cardholder may register for the card product leveraging service by providing data to a customer service representative, by completing a form that is then received by a mail processing center, or via a third-party (e.g., by opting-in where a participating issuing bank passes the information to the card product leveraging service).

In one or more embodiments, the card product leveraging system is associated with a payment network. In one or more embodiments, the merchant's acquirer financial institution (FI) contacts a payment network with a purchase transaction request and the payment network applies the leverage module to select one of the card product accounts for use in the purchase transaction. Then the payment network identifies the cardholder's issuer financial institution (FI) and then forwards an authorization request for the purchase transaction to the issuer FI. If all is in order, the issuer FI authorizes a transfer of funds from that selected card product account to the merchant's payment account in the acquirer FI. The vehicle for the funds transfer may therefore be a conventional payment transaction of the type now supported by at least one payment card system. Upon authorization and/or completion of the payment transaction, the acquirer FI may confirm to the merchant that the funds transfer has occurred (or is assured to occur subsequently during conventional clearing operations). In response to receiving the funds transfer confirmation, the merchant then transfers ownership of the goods to the cardholder, or may accept the confirmation as payment for services rendered or to be rendered to the cardholder. Is should be understood, however, that the processes described herein may utilize a conventional payment network, and/or the internet, and/or any other network and/or payment channel.

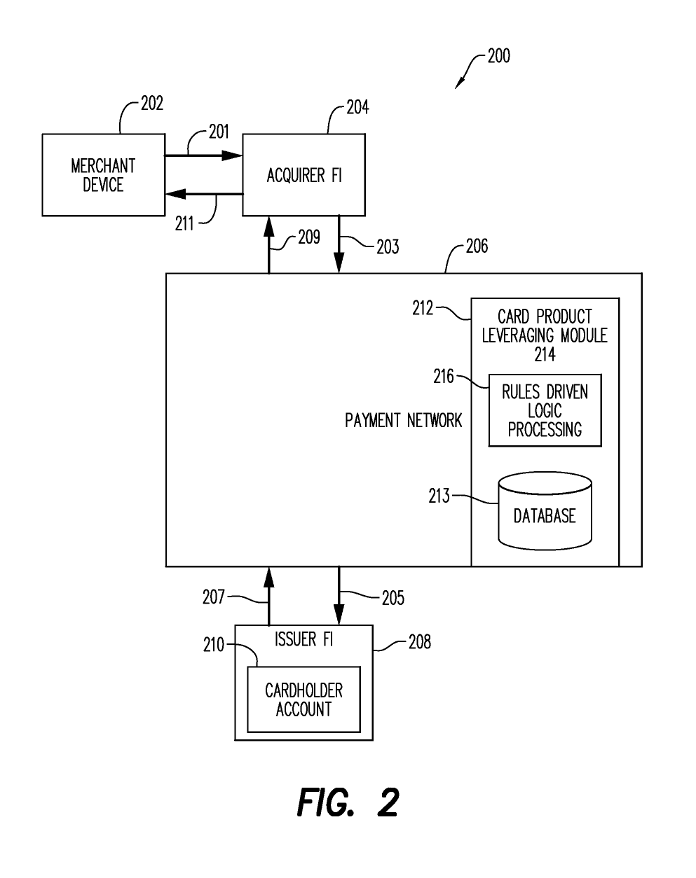

FIG. 2 is a block diagram of a transaction handling system 200 including components configured to operate in accordance with aspects of the processes described herein. It should be understood that the various components shown in FIG. 2 may be a subset of a larger system for leveraging card products for cardholders and for facilitating purchase transactions between cardholders and merchants via card products, and/or for facilitating payment transactions between one or more financial institutions (FIs) such as acquirer and issuer banks. In accordance with some implementations, cardholders and merchants may be unaware that processing by the card product leveraging system has occurred or is occurring during purchase transactions.

The transaction handling system 200 includes a merchant device 202 which may be, for example, a POS terminal or a merchant website. If the merchant device is a POS terminal, such as a cash register in a retail store location, it may be configured to operate for the most part in a conventional manner, or it may have functionality that actively contributes to the transaction flow illustrated in FIG. 2. The POS terminal 202 may, for example, be found in any type of business establishment, and can be configured to transmit a merchant identifier, purchase transaction information, and other data to the Card Product Leveraging computer system 212. Transmitting the transaction information from the merchant device 202 to the Card Product Leveraging System 212 may be via wireless communication such as NFC (near field communication), for example, or any other suitable communication method.

The transaction handling system may include an acquirer financial institution (FI) 204 that issued a merchant financial account (not shown), which may be, for example, a payment card account, a payment network 206 (for routing transactions, for example, from the issuer FI 208 to the acquirer FI 204). While only one issuer FI 208 is shown herein, a plurality of issuer FIs may be included in the system 200, each of which may represent banks, for example, that issued one or more cardholder accounts to the cardholder, such as cardholder account 210). The transaction handling system 200 may also include a card product leveraging system 212, which in some embodiments includes a card product leveraging module 214 (“leverage module”). In one or more embodiment, the card product leveraging system 212 may be part of the payment network 206. In one or more embodiments, the system 212 may be part of at least one of the other components of the system 200 shown in FIG. 2. The leverage module 214 may include a rules driven logic processing module 216 and one or more databases 213. The card product leveraging module 214 and rules driven logic processing module 216, may be separate computers or computer systems, or may be components of a single computer or computer system. It should also be understood that the various components and/or computer systems depicted in FIG. 2 may be configured to communicate directly with one another via, for example, secure connections, or may be configured to communicate via the Internet and/or via other types of computer networks and/or communication system in a wired or wireless manner. In addition, for ease of understanding, the transaction handling system 200 generally shows only components that are involved in handling one transaction, but in practice many more devices, such as the merchant devices 202 and acquirer FIs 204, may be included.

As part of a purchase transaction, arrows 201-211 represent communications between the components of the transaction handling system 200. As part of a purchase transaction, the merchant device 202 transmits 201 a purchase authorization request to the merchant's acquirer FI 204. In one or more embodiments, purchase transaction information may include a merchant identifier, a transaction amount and product identification data. The merchant acquirer FI 204 receives the purchase transaction authorization request and then transmits 203 the authorization request to the payment network 206 (which includes one or more computers and/or computer systems). The payment network 206 receives the purchase transaction authorization request and determines whether the cardholder's payment account number (PAN) falls within a range of PANs corresponding to proxy or “dummy” account numbers provided by the card product leveraging system 212. The “dummy” account number may be for a composite account registered with the card product leveraging system 212, wherein the composite account includes a collection of two or more card products. When the PAN does not match a “dummy” account number, the purchase transaction continues per conventional processes. When the PAN is matched to a “dummy” account number, the payment network 206 then applies the card product leveraging system 212 for processing. The card product leveraging module 214 utilizes this transaction data (and in some cases, additional data) to determine one or more card product accounts to use in that particular purchase transaction, for example, to maximize value for the cardholder. Maximizing value for the cardholder may be based on preferences provided by that cardholder that do not necessarily equate to saving the most money or earning the maximum number of points in a rewards system. For example, the parent of a college student offers to pay for 50% of all grocery purchases. As such, purchases in the grocery category are split evenly between the parent's credit card and the student's debit card. As will be further described below, the card product leveraging module 214 then selects an account associated with at least one card product to process the purchase transaction. The payment network 206 then identifies the issuer bank for the selected card product as the issuer FI 208 and then routes 205 the authorization request to the issuer FI 208. If all is in order (i.e., the cardholder has adequate credit to pay for the purchase), then the Issuer FI 208 transmits 207 a positive or acceptance authorization response to the payment network 206 which routes 209 the authorization acceptance response to the acquirer FI 204 that may include authorization of a payment transfer from the cardholder's cardholder account 210 to the merchant account. If all is not in order (e.g., the cardholder does not have adequate credit to pay for the purchase), then the Issuer FI 208 transmits 207 a negative or decline authorization response to the payment network 206, which routes the decline to the card product leveraging system 212. In the case of decline, the card product leveraging module 214 may iteratively select another card product to provide to the Issuer FI 208 until an authorization acceptance response is provided by the Issuer FI 208 or an end condition is achieved. In one or more embodiments, the cardholder has indicated a particular other card product to provide as a default card product in the event the selected card product is declined. In some embodiments, the merchant's acquirer FI 204 then transmits 211 the authorization response to the merchant device 202 to inform the merchant of the status of the purchase transaction (e.g., authorized or denied). When the merchant device 202 receives a positive authorization confirmation message the merchant may allow the sale or other exchange of value to be completed. Except for the card product leveraging system aspect, such a purchase transaction process may be entirely conventional.

It should be understood that, in practice the transactions system 200 may include numerous Issuing FIs and a plurality of Acquirer FIs all connected to the payment network 206 and a large number of merchant devices 202.

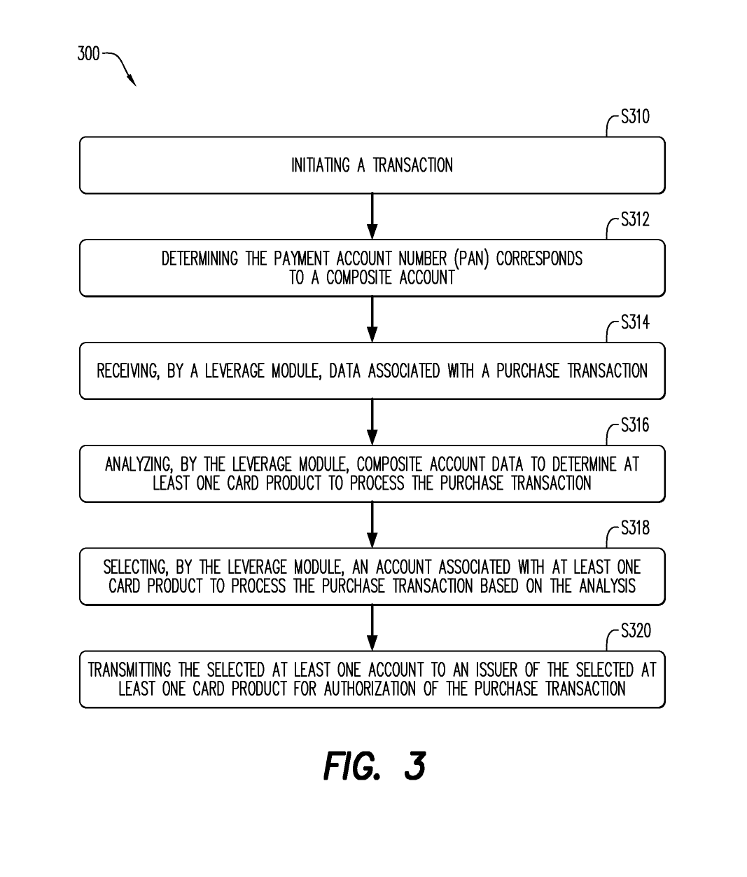

FIG. 3 illustrates a method 300 that might be performed by all or some of the elements of the system 200 described with respect to FIG. 2 according to some embodiments. The flow chart(s) described herein do not imply a fixed order to the steps, and embodiments of the present invention may be practiced in any order that is practicable. Note that any of the methods described herein may be performed using any suitable combination of hardware (e.g., circuit(s)), software or manual means. For example, a non-transitory computer-readable storage medium (e.g., a fixed disk, a floppy disk, a CD, a DVD, a Flash drive, or a magnetic tape) may store thereon instructions that when executed by a machine result in performance according to any of the embodiments described herein. In one or more embodiments, the card product leveraging system 212 is conditioned to perform the process 300, such that the system 212 is a special purpose element configured to perform operations not performable by a general purpose computer or device.

In one or more embodiments, prior to beginning process 300, a cardholder pre-registers two or more of their existing card product accounts with the card product leveraging system 212. In one or more embodiments, the pre-registration process may be via a web interface, a customer service representative, a form received by a mail processing center, or by a third party (e.g., a cardholder opts-in to participate/register with the card product leveraging system 212 via a participating issuing bank that provides one of the existing card product accounts. The issuing bank may then pass the information to the card product leveraging system 212.) In other or more embodiments, the card product leveraging system 212 is administered and maintained by the payment network or processor 206 (e.g., MasterCard®). Other suitable pre-registration methods may be used.

The data collected during the pre-registration process may include for example, for each card product registered with the system, at least one of card product account details (e.g., card number, expiration date, etc.), an account nickname, a credit limit, balance information, an interest rate, currency conversion fees/rates, an account type (e.g., business vs cardholder, credit vs debit vs. prepaid), and usage preferences. Other suitable data may be collected.

The usage preferences may include one or more preferences or rules for the card product leveraging module 214 to apply to the request for authorization to select the appropriate card product. When registering with the card product leveraging system 212, the cardholder may select usage preferences based on that cardholder's goals and/or priorities in terms of benefits associated with the two or more card products. For example, when registering, the cardholder may select user preferences directed towards increasing cash back, earning air-line miles, having zero liability or better warranty protection when making purchases, travel benefits and/or receiving rebate and/or receiving discounts, or any other suitable goals.

A usage preference may include, for example, an indication of whether the card is the default card. For example, a default card may be the card that is used when there are no rules specified for a particular transaction. In one or more embodiments, the default card may also be used as a back-up to a preferred card should the preferred card be denied for any reason. In one or more embodiments, the default card indication may be captured as a flag (Y/N) or as an ordered ranking (e.g., use Card A first and Card B second, etc.). The usage preferences may also include processing preferences (e.g., an indication of whether the card should be used as a debit card or a credit card) and an indication of categories or particular merchants that should be billed to the card. In one or more embodiments, this information may be indicated by merchant category code (MCC) or other suitable classification. For example, a cardholder has a business account and a personal account. The cardholder wants to use the business account for all travel and entertainment purchases, and their personal account for all other purchases. Other usage preferences may include:

transaction type (e.g., recurring payments and/or returns) to be billed to the card. For example, a cardholder has a number of recurring payments set up through the “dummy” account. An advantage of one or more embodiments is if, for example, one of the cards linked to the “dummy” account is stolen, the cardholder simply updates the “dummy” account with their updated card number, when they receive the replacement card, and the recurring payments continue to bill the dummy account without any need for the cardholder to notify the merchants that bill recurring payments;

maximum amount to be billed to a card. For example, a cardholder is carrying a balance on a card and has another card that they pay in full each month. For everyday purchases under $100, the cardholder specifies to use the zero-balance account. For larger ticket purchases (greater than $100, and returns), the cardholder specifies to use the account with a balance;

split logic whereby the purchase is split among two or more cards. For example, for purchases greater than a threshold amount, bill a particular percentage or absolute amount of a purchase to card A, and the remaining percentage or absolute amount to card B. As another example, a small business owner uses a percentage share to differentiate between work related vehicle expenses (75%) and personal vehicle expenses (25%). All vehicle related purchases (e.g., maintenance, lease, gasoline) are split between two accounts to aid with accounting. As another example, a gift card is registered. The gift card amount is $100. Once the $100 of the gift card is used, the remaining charges may be sent to a default card. As yet another example, a per diem is imposed on a corporate card. Once the cumulative daily purchases exceed $100 on the corporate card, all other purchases will be applied to the cardholder's personal card. As another example, a parent will pay for their child to charge up to $25 for restaurant purchases on the parent's credit card. Any charges beyond $25 will be applied to the child's personal debit card;

time preference (day of the week, time or period of day) when purchases may be billed to the card (e.g., weekday, 9-5 purchases are billed to card A; Monday and Wednesday lunchtime dining purchases are billed to card A);

geography of the purchase location preferences (e.g., international purchases billed to card A; out-of-state purchases billed to card A); and

currency preferences (e.g., non-United States Dollar (USD) purchases billed to card A; non-USD purchases billed to the card with the cheapest currency conversion fees, as specified by the cardholder's preferences). For example, a cardholder has a card that has no rewards but offers a low fee for currency conversion. For domestic purchases or any purchases that use USD, the cardholder specifies to use a rewards card that offers airline miles for purchases, and for any non-USD purchases specifies to use the card that has low fees for currency conversion, as specified by the cardholder's preferences.

The cardholder may also note other usage preferences such as payment card restrictions, payment card balances, and payment card maintenance fees. In one or more embodiments, the cardholder may rank these preferences in an order from most important to least important, and thus in some embodiments may be prompted to assign a weight to each selected preference. It is noted that any combination of preferences may be selected for a particular card.

The data may be stored in one or more databases 213. As shown in FIG. 2, the payment system 206 may access the database 213 via the card product leveraging system 212.

As part of the pre-registration process, the card product leveraging system 212 may provide the cardholder with a “dummy” or proxy account number, and in some embodiments a “dummy” card product that may be used to access all of the registered card products. The “dummy” account number or “dummy” PAN may be for a composite account registered with the card product leveraging system 212, wherein the composite account includes a collection of two or more card products. The use of a single account that stores all of the cardholder preferences may enable a cardholder to more easily leverage the different card products without having to remember all of the details associated with each card product. For example, a cardholder likes to constantly alternate between card accounts to leverage different offers (e.g., rewards, interest rates, balance revolving, paranoia about having a longstanding account with a single entity, etc.). The cardholder wants to carry a single card that may allow them to use a persistent account number despite constantly changing the cards they use. In one or more embodiments, the cardholder may use the “dummy” account as a proxy for whatever card they prefer. In one or more embodiments, the “dummy” account may reduce the instances of declines for a payment product in that a back-up account may be designated in the event of an authorization decline. Another advantage provided by embodiments is the ease of implementation in that without the single card, it may be difficult and/or unpleasant to ask the merchant to divide the purchase amount between different cards. As another example, a cardholder may have a plurality of prepaid cards. Another advantage provided by embodiments is the ease of fully defunding prepaid/gift cards. For example, the cardholder wants to use up balances of their prepaid cards without having to consciously monitor their balances or try to spend small remainders on cards. In some embodiments, the cardholder registers all the prepaid cards with the card product leveraging system 212, and specifies that purchases may span multiple card products (e.g., a $250 purchase may use up two $50 prepaid cards, and the remaining balance may be applied to a debit card).

Referring again to FIG. 3, at S310 a cardholder having a “dummy” account initiates a purchase authorization transaction, for example, at a POS terminal located at a merchant retail store, or at a merchant's Internet website. When the cardholder initiates the purchase authorization transaction, the cardholder provides the “dummy” account information to the merchant via conventional ways (e.g., swiping the card at the POS terminal, providing the card to proximity reader, entering the card number, etc.). As described above, the purchase authorization transaction request follows the conventional channels (e.g., is routed from the merchant device 202 until it reaches the payment network 206). At S312, the payment network 206 receives the purchase transaction authorization request and determines whether the cardholder's PAN falls within a range of PANs corresponding to a proxy or “dummy” account number provided by the card product leveraging system 212. When the PAN does not match a “dummy” account number, the purchase transaction continues per conventional processes. When the PAN is matched to a “dummy” account number, the payment network 206 then transmits the purchase transaction authorization request to the card product leveraging system 212 for processing. In some embodiments, instead of the payment network 206 identifying a “dummy” account via a PAN, the payment network 206 may identify a transaction type code associated with the “dummy” account that may be used to differentiate the transaction from “regular”/non-dummy account transactions.

The card product leveraging module 214 receives the transaction authorization request including the data associated with the purchase transaction at S314. Then in S316, the card product leveraging module 214 accesses the database 213 and analyzes the composite account data, including the usage preferences and rules associated with the card products, to determine at least one card product to process the purchase transaction. In one or more embodiments, the card product leveraging module 214 may access the rules driven logic processing module 216 during the analysis of the composite account data stored in the database 213. Then at S318 the card product leveraging module 214 selects one or more card products to process the purchase transaction based on the analysis. In one or more embodiments, the payment network 206 identifies the issuer bank for the selected card product as the issuer FI 208. The leverage processor module 214 then initiates one or more payment transactions on the payment product account(s) by transmitting the selected card product to the issuer FI 208 via the payment network 206 in S320.

As described above, if all is in order (i.e., the cardholder has adequate credit to pay for the purchase), then the Issuer FI 208 transmits a positive or acceptance authorization response to the payment network 206 which routes the authorization acceptance response to the acquirer FI 204. The acceptance authorization response may include authorization of a payment transfer from the cardholder's cardholder account 210 to the merchant account. In some embodiments, the merchant's acquirer FI 204 then transmits the authorization response to the merchant device 202 to inform the merchant that the purchase transaction has been authorized. When the merchant device 202 receives the authorization acceptance confirmation message the merchant may allow the sale or other exchange of value to be completed. Except for the card product leveraging system aspect, such a purchase transaction process may be entirely conventional

If all is not in order (e.g., the cardholder does not have adequate credit to pay for the purchase), then the Issuer FI 208 transmits 207 a negative or decline authorization response to the payment network 206. The payment network 206 then, which may route the decline to the card product leveraging system 212. In the case of decline, the card product leveraging module 214 iterates steps S316 and S318 to select at least one other card product to use in the purchase transaction. In one or more embodiments, the cardholder may specify a particular “other” card to use as a default card when a selected card has been declined. In one or more embodiments, the card product leveraging module 214 may follow additional cardholder preference logic regarding cascading authorizations, for example, whereby one or more authorizations may be run on other payment product accounts that may be authorized for purchases in the event a previously selected card product is unavailable. For example, if the selected card product does not have sufficient balance, the card product leveraging module 214 may, based on user preferences, select another card for the payment (e.g., either for the full amount of the payment or the “spillover amount”—the difference between what is available from the first selected card and “another” card). In one or more embodiments, when a purchase transaction is split between multiple cards, an authorization may be run on each payment product account, and both authorizations may need approval before the transaction is submitted. However, the merchant may consider this one transaction, even though multiple authorizations may be conducted in the background. In one or more embodiments, the card product leveraging module 214 reconciles this “one-to-many” relationship within its data infrastructure. In one or more embodiments, when a purchase transaction is split between multiple cards, a merchant transaction identifier may be generated that captures split payments as belonging to the same purchase interaction. In one or more embodiments, the card product leveraging module 214 iterates steps S316 and S318 to select a card product to provide to the Issuer FI 208 until an authorization acceptance response is provided by the Issuer FI 208 or an end condition is achieved. When an authorization acceptance response is provided by the Issuer FI, the process continues as described above, and the merchant is informed of the acceptance authorization. In one or more embodiments, the end condition may be when the card product leveraging module 214 determines other card products are unavailable to process the purchase transaction, or the card product leveraging module 214 has failed to provide another card product in a pre-determined amount of time. If an end condition is achieved, the payment network 206 transmits a decline authorization response to the merchant via the merchant's acquirer FI 204 to inform the merchant that the purchase transaction has been declined.

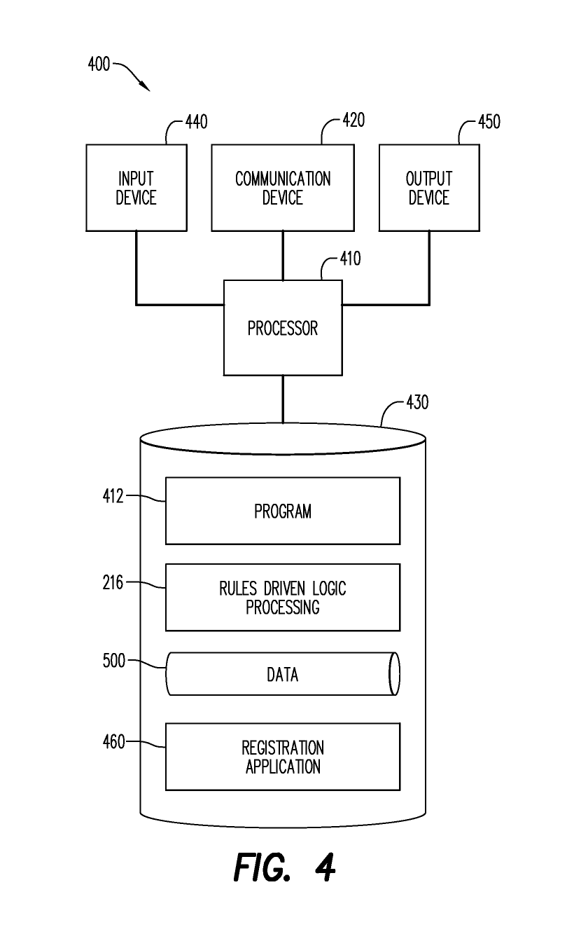

Note that the embodiments described herein may be implemented using any number of different hardware configurations. For example, FIG. 4 illustrates a Card Product Leveraging Platform 400 that may be, for example, associated with the card product leveraging system 212 of FIG. 2. The Card Product Leveraging Platform 400 comprises a card product leveraging processor or module 410, such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more users or computers. The Card Product Leveraging Platform 400 further includes an input device 440 (e.g., a computer mouse and/or keyboard to enter information about card products and preferences) and an output device 450 (e.g., a computer monitor or printer to output a transaction information report and/or evaluation).

The processor 410 also communicates with a storage device/memory 430. The storage device 430 may comprise any appropriate information storage device, including combinations of magnetic storage devices (e.g., a hard disk drive), optical storage devices, mobile telephones, and/or semiconductor memory devices. The storage device 430 stores a program 412 and/or card product leveraging platform logic 216 for controlling the processor/module 410. The processor/module 410 performs instructions of the programs 412, 216, and thereby operates in accordance with any of the embodiments described herein. For example, the processor 410 may receive a purchase authorization request which may then be analyzed by the processor 410 to automatically determine which card product to use in the transaction.

The programs 412 stored by the storage device 430 may include a cardholder registration application 460 that manages a process by which cardholders or customers (i.e., cardholders) may register or enroll themselves with the card product leveraging system 400. As described above, in some embodiments, the cardholder enrollment process may allow the cardholders to enroll themselves by accessing a suitable web page hosted by the card product leveraging system 400, or by other enrollment methods. The information obtained from the cardholder during the enrollment process may include one or more payment card account numbers, one or more mobile telephone numbers (or other mobile identifiers), preference data and/or other information concerning the cardholder's payment card accounts. In one or more embodiments, the enrollment process may also require the cardholder to select a PIN (personal identification number) to be used for security purposes in connection with purchase transactions to be initiated by the cardholder, and/or for use by a cardholder to login and change one or more preference settings, for example. Other security measures may also be put in place, including industry-standard cardholder security processes and/or procedures.

The programs 412, 216 may be stored in a compressed, uncompiled and/or encrypted format. The programs 412, 216 may furthermore include other program elements, such as an operating system, a database management system, and/or device drivers used by the processor 410 to interface with peripheral devices.

As used herein, information may be “received” or “retrieved” by or “transmitted” to, for example: (i) the Card Product Leveraging Platform 400 from another device; or (ii) a software application or module within the Card Product Leveraging Platform 400 from another software application, module, or any other source.

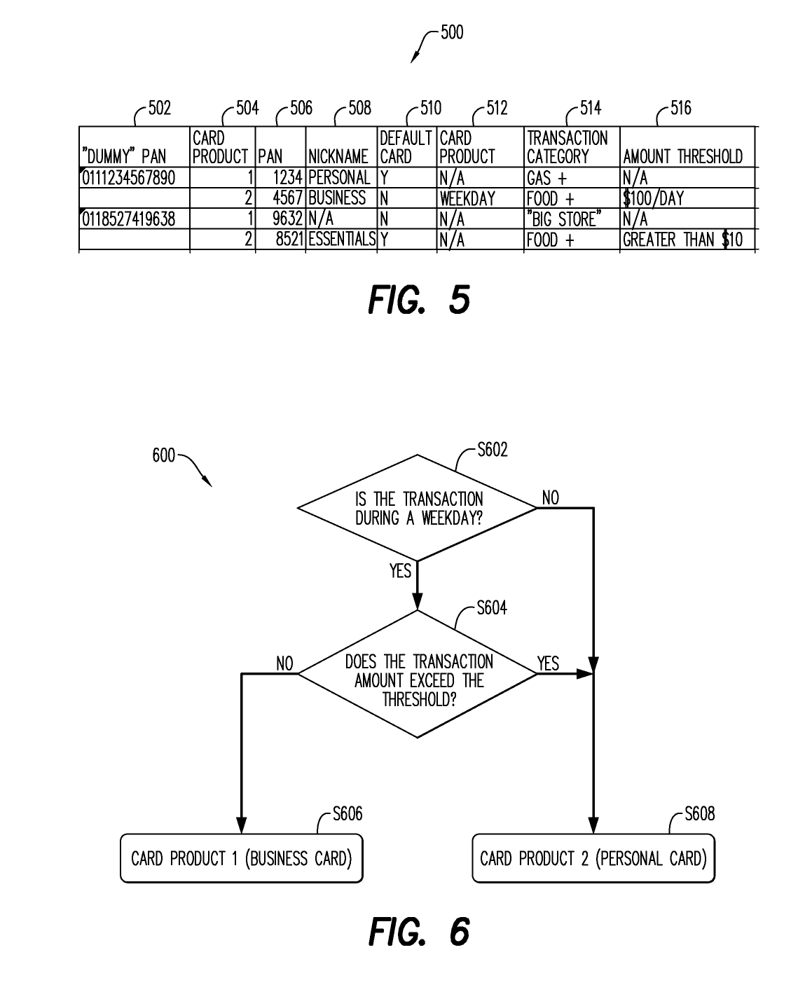

In some embodiments (such as shown in FIG. 4), the storage device 430 further stores a card product leveraging database 500. Some examples of databases that may be used in connection with the Card Product Leveraging Platform 400 will now be described in detail with respect to FIG. 5. Note that the database described herein is only an example, and additional and/or different information may actually be stored therein. Moreover, various databases might be split or combined in accordance with any of the embodiments described herein.

Referring to the card product database in FIG. 5, a table 500 is shown that represents the card product database 500 that may be stored in memory 430 (Card Product Leveraging Platform 400) according to some embodiments. The table 500 may include, for example, entries identifying profile information for two or more card products associated with a cardholder or subscriber. The table 500 may define fields 502, 504, 506, 508, 510, 512, 514 and 516 for each of the entries. The fields 502, 504, 506, 508, 510, 512, 514 and 516, may, according to some embodiments, specify: a dummy account number 502, a card product 504, a Card Account PAN 506, a card nickname 508, a default card indicator 510, a transaction time/date preference 512, a transaction category 514 and an amount threshold 516. Other suitable fields may be used in addition to, or instead of, the fields listed herein. In one or more embodiments, the transaction category 514 may include multiple categories, which may be ranked by the cardholder. For example, while a cardholder may prefer to use a particular card for all gas purchases, the cardholder may also want to use that card for other purchases. While the plus symbol “+” is used to represent multiple categories in the table 500, other indicators may be used. The card product leveraging database 500 may be created and updated, for example, based on information electrically received on a periodic basis.

Turning to FIG. 6, a method 600 that may be performed by all or some of the elements of the card product leveraging system 212 described with respect to FIG. 2 to select a card product for use in a purchase transaction is illustrated according to some embodiments. In particular, the method 600 described by FIG. 6 provides an example to further describe steps S316 and S318 described above with respect to the method 300 described by FIG. 3. In the example described herein, the cardholder may have two cards—one for business use and one for personal use. The cardholder uses his “dummy” account to purchase gas on Tuesday for $60, and lunch on that same day for $60.

When the cardholder registers the cards with the card product leveraging system 212, the cardholder indicates that the business card is to be used for purchases during a weekday (e.g., Monday through Friday) up to a certain spending amount per day, otherwise the personal card is to be used, as indicated for Dummy PAN ending in “890” in FIG. 5, for example.

The cardholder initiates a transaction per the process described above with respect to FIG. 3. The card product leverage module 214 analyzes the account data stored in Table 500, for example, for dummy PAN ending in “890” per S316.

In S602, the card product leverage module 214 determines, based on the information in the Table 500, whether the transaction is during a weekday. If the transaction is during a weekday, the method proceeds to S604 and the card product leverage module 214 determines, based on the information in Table 500, whether the transaction amount exceeds the per diem threshold. If the transaction amount does not exceed the per diem threshold, the card product leverage module 214 selects Card Product 1 (business card) to use in the transaction in S606.

If in S602, the card product leverage module 214 determines the transaction is not during a weekday (e.g., Saturday or Sunday), the method proceeds to S608, and the card product leverage module 214 selects Card Product 2 (personal card) to use in the transaction.

Similarly, if the card product leverage module 214 determines in S604 that the transaction amount exceeds the per diem threshold, the card product leverage module 208 selects Card Product 2 (Personal Card) to use in the transaction.

Referring again to the example, for the gas purchase of $60, the card product leverage module 214 applies the method 600 described in FIG. 6 and selects Card Product 1 to use for the transaction in S606, as the purchase is during a weekday (Tuesday), and does not exceed the daily threshold ($100). In one or more embodiments, the card product leverage module 214 tracks the purchases made with each particular card. For the subsequent lunch purchase of $60, the card product leverage module 214, again applies the method 600 described in FIG. 6, and selects Card Product 2 to use for the transaction in S608. In particular, the card product leverage module 214 stores and tracks the purchases made with Card Product 1, and determines with the $60 for gas for the first transaction, the $60 for lunch with the second transaction would exceed the $100/day threshold (516) in S604, and thereby selects Card Product 2 to purchase lunch. In one or more embodiments, the cardholder may also have included split logic such that Card Product 1 is used for $40 of the lunch purchase, and Card Product 2 is used for the remaining $20 of the lunch purchase thereby using Card Product 1 until the threshold is met.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a card product leveraging module. The method steps can then be carried out using the distinct software modules and/or sub-modules of the system, as described above, executing on one or more hardware processors 410 (FIG. 4). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
receiving, by a leverage module, data associated with a purchase transaction;
determining that an account identifier associated with the received data identifies a composite account, wherein the composite account includes a collection of two or more card products;
analyzing, by the leverage module, composite account data to determine at least one card product of the collection of card products to process the purchase transaction;
selecting, by the leverage module, an account associated with at least one card product to process the purchase transaction based on the analysis;
transmitting, by the leverage module, the selected at least one account to an issuer of the selected at least one card product for authorization of the purchase transaction.

2. The method of claim 1, further comprising:
receiving, by a merchant device, an authorization approval from the issuer of the selected at least one card product.

3. The method of claim 1, further comprising:
receiving, by the leverage module, an authorization denial from the issuer of the selected at least one card product;
analyzing, by the leverage module, composite account data to determine at least one other card product of the collection of card products to process the purchase transaction;
selecting, by the leverage module, the at least one other card product to process the purchase transaction based on the analysis; and
transmitting, by the leverage module, the selected at least one other card product to an issuer of the selected at least one card product for authorization of the purchase transaction.

4. The method of claim 3, wherein selecting at least one other card product is iterative until one of: the selected card product transmitted by the leverage module to the issuer receives an authorization approval, or and end condition is achieved.

5. The method of claim 4, wherein an end condition is one of another card product is unavailable for selection or another card product is not selected in a predetermined amount of time.

6. The method of claim 1, further comprising, identifying a split payment belongs to the same purchase.

7. The method of claim 1, further comprising, prior to receiving, by the leverage module, data associated with the purchase transaction, registering two or more card products with the leverage module.

8. The method of claim 7, wherein registering two or more card products further comprises:
providing, to the leverage module, composite account data.

9. The method of claim 8, wherein composite account data includes for each card product, at least one of card product account details, an account nickname, a credit limit, balance information, an interest rate, currency conversion fees, currency conversion rates, an account type, and usage preferences.

10. The method of claim 7, wherein registering two or more card products further comprises:
providing data to the leverage module via at least one of a web interface, a customer service representative, a form received by a mail processing center, and a third party.

11. The method of claim 1, wherein analyzing, by the leverage module, composite account data to determine at least one card product of the collection of card products to process the purchase transaction further comprises:
determining, by the leverage module, for each card product of the collection of card products at least one of a default card status, a processing preference, and one or more usage rules, based on the composite account data.

12. The method of claim 11, wherein the one or more usage rules further comprises data related to at least one of:
categories authorized to be billed with the card product, amount thresholds authorized to be billed with the card product, transaction types authorized to be billed with the card product, split logic associated with usage of the card product, time preferences associated with usage of the card product, geography preferences associated with usage of the card product, and currency preferences associated with usage of the card product.

13. A system comprising:
a communication device operative to communicate with a merchant device to obtain a request for authorization to use a payment account number for a transaction;
a leverage module, in communication with the communication device, to receive the request for authorization;
a non-transitory computer medium operably coupled to the leverage module, the non-transitory computer medium storing instructions configured to cause the leverage module to:
receive, by a leverage module, an account number associated with a
composite account and data associated with a purchase transaction, wherein the composite account includes a collection of two or more card products;
analyze, by the leverage module, composite account data to determine at least one card product of the collection of card products to process the purchase transaction;
select, by the leverage module, an account associated with at least one card product to process the purchase transaction based on the analysis;
transmit, by the leverage module, the selected at least one account to an issuer of the selected at least one card product for authorization of the purchase transaction.

14. The system of claim 13, wherein an authorization denial is received by the leverage module from the issuer of the selected at least one card product, and in response to the received authorization denial, the leverage module is operative to:
analyze the composite account data to determine at least one other card product of the collection of card products to process the purchase transaction;
select the at least one other card product to process the purchase transaction based on the analysis; and
transmit the selected at least one other card product to an issuer of the selected at least one other card product for authorization of the purchase transaction.

15. The system of claim 14, wherein the leverage module is operative to re-iterate the determining at least one other card product step until one of: the selected card product transmitted by the leverage module to the issuer receives an authorization approval, or an end condition is achieved.

16. The system of claim 15, wherein an end condition is one of another card product is unavailable for selection or another card product is not selected in a predetermined amount of time.

17. The system of claim 13, further comprising, identifying a split payment belongs to the same purchase transaction.

18. The system of claim 13, wherein composite account data further comprises, for each card product, at least one of card product account details, an account nickname, a credit limit, balance information, an interest rate, currency conversion fees, currency conversion rates, an account type, and usage preferences.

19. The system of claim 13, wherein each card product of the collection of card products is associated with a default card status, a processing preference, and one or more usage rules.

20. The system of claim 19, wherein the one or more usage rules further comprises data related to at least one of categories authorized to be billed with the card product, amount thresholds authorized to be billed with the card product, transaction types authorized to be billed with the card product, split logic associated with usage of the card product, time preferences associated with usage of the card product, geography preferences associated with usage of the card product, and currency preferences associated with usage of the card product.
